(19) United States
(12) Patent Application Publication
(10) Pub. No.: US 2024/0411806 A1
(43) Pub. Date: Dec. 12, 2024

(54) CHARACTERISTIC-BASED MEDIA ANALYSIS AND SEARCH

(71) Applicant: Incantio Inc., Vashon, WA (US)

(72) Inventors: Tiffany Lynn Larsen, Vashon, WA (US); Anthony Alfred Mann, Vashon, WA (US); Daniel Mead Newcomb, Vashon, WA (US)

(73) Assignee: Incantio Inc., Vashon, WA (US)

(21) Appl. No.: 18/737,704

(22) Filed: Jun. 7, 2024

Related U.S. Application Data
(60) Provisional application No. 63/471,912, filed on Jun. 8, 2023.

(51) Int. Cl. G06F 16/632; G06F 16/683; G06F 40/58; G10H 1/00

(52) U.S. Cl. CPC G06F 16/634; G06F 16/683; G06F 40/58; G10H 1/0008; G10H 2210/031

(57) ABSTRACT

The application is directed to a system in which music artists can submit songs to a media library and content creators can search for songs in the media library that are suitable for their use; e.g. for a scene in a video or a playlist. In some examples, a corresponding method can include (i) obtaining an input media item, (ii) determining a vibe of the input media item based on musical features extracted from the input media item, (iii) identifying a matched media item based on searching a database of media items for media that matches the vibe of the input, and (iv) outputting an indicator of the matched media item or items.

### CROSS REFERENCE TO RELATED APPLICATIONS

The present application claims the benefit under 35 U.S.C. § 119 (e) of U.S. Provisional Application No. 63/471,912, titled “Characteristic-based media analysis and search” and filed Jun. 8, 2023, the entire contents of which are incorporated herein by reference.

### BACKGROUND

Content creators make commercials, TV shows, movies, and videos for social media like TikTok and YouTube. Much of this content is accompanied by music. Most of this music must be licensed for use. This type of music license is called a “sync license,” since the music is synchronized with the video.

### BRIEF DESCRIPTION OF DRAWINGS

FIG. 1 is a flow diagram of an example method for adding media to a media library.

FIG. 2 is a flow diagram of an illustrative method for uploading an individual song to a media library.

FIG. 3 is a flow diagram of an illustrative method for searching a media library.

FIG. 4 is a flow diagram for an additional illustrative method for searching a media library.

FIG. 5 is a flow diagram of an illustrative method for conducting a media search using attribute ranges.

FIG. 6 is an illustrative method for using natural language (NL) queries to search for songs that fit a particular vibe.

FIG. 7 is a flow diagram of an illustrative method for finding songs that have the same vibe as a video segment.

FIG. 8 is a flow diagram of an illustrative method for finding song matches based on a saved song set.

FIG. 9 is a flow diagram of an illustrative method for performing and refining a search.

FIG. 10 is a flow diagram of an illustrative method for creating and updating a workspace.

FIG. 11 is a flow diagram of an example method for uploading a video to a workspace.

FIG. 12 is a block diagram of an illustrative system for performing media searches based on characterizations of acoustic and/or emotive content of input media.

FIG. 13 is a block diagram of an additional illustrative system for performing media searches based on characterizations of acoustic and/or emotive content of input media.

FIG. 14 is a flow diagram of an illustrative method for identifying matched media items based on acoustic and/or emotive properties of input media.

FIG. 15 is a block diagram of a computing device with which some embodiments may operate.

### DESCRIPTION OF EXAMPLE EMBODIMENTS

Described herein are examples of techniques for performing characteristic-based media analysis and searching. Such techniques may include determining a characterization of acoustic content and emotive content of the audio for an input media item, such as based at least on one or more music attributes of the input media. Some such techniques may include identifying one or more matched pieces of media based on searching a set or database of media for media with matching acoustic content and/or matching emotive content the characterization of acoustic and/or emotive content of the audio of the input media. An identification of matched media may be output as potential matches to the input media with respect to acoustic content and/or emotive content.

Also described herein are examples of techniques for generating a searchable set or database of media items, which in some cases may include obtaining input media that includes audio, determining characterizations of acoustic and emotive content of the audio based on musical attributes extracted from the audio, and storing an indicator of the input media in association with the characterizations of the acoustic content and the emotive content of the audio.

Traditionally, the music for sync licensing comes from established artists via their record label publishers. Record labels review and approve catalogs of music for sync licensing, including through licensing options like a “pool” license for music in the category. These catalogs or music pools may include information about each available piece of media such as download audio quality, musicality quality, and/or licensing availability, making such music easy for content creators to find and use.

Human content creators have traditionally needed to manually listen to and review media while looking for music to incorporate into their content. Such manual review of media can be slow and burdensome, leading to delays in new media being available via the catalogs. Similarly, media creators are generally required to navigate different catalogs for different styles of music, different record labels, different artists, etc. Navigating such a wide range of catalogs to find a desired media item may be time-intensive and finding a desired piece of media may prove difficult.

There are millions of songs by independent artists that could be suitable for inclusion in content by content creators, but there are barriers to their use, including:
1. Songs that are not organized into a catalog licensing pool: independent artists do not have a record label to compile their music into a catalog. The number of songs created by independent artists is so large that all such songs, or even a significant fraction of such songs, cannot be manually compiled for review.
2. Download audio quality, and/or musicality quality, of songs that has not been vetted: review by a label or other organization or person reporting on what music may be found pleasing, acceptable, or interesting by a population of listeners, and thus potentially interesting for inclusion in content creators' content, can help assure content creators that they are selecting a suitable piece of media for inclusion into their work.
3. Creators may want a song with a particular sound or that conveys a particular emotion to match other media (e.g., images or video) of their content, and there are too many songs to manually review for songs that match those desired characteristics.

A content creator may desire a particular piece of content they create—e.g. a video scene—to present a certain vibe, and a content creator may want to find music content matching the desired vibe of the content to use as music to be played during a portion of or an entirety of the video (e.g., as background music).

Some conventional media library search engines may provide only a limited set of attributes to search on. Moreover, these same search engines may also lack the capacity to search attributes that are important for establishing the vibe of a piece of music. For these other search engines, content creators tend to shoulder the burden of determining which song attribute ranges to use to match the vibe of the video segment. This can be an indirect, imprecise, and sometimes arduous process.

The inventors have recognized and appreciated that content creators and artists (including independent artists or artists represented by record labels) may benefit from a tool to case the burden of content creators of identifying music with desired characteristics. Meanwhile, artists without a support team or record label may benefit from a way to add their songs to a data set, catalog, and/or licensing pool for content creators to discover their music and license one of their songs for use in a video. Record label artists and their record labels may likewise benefit from a tool that enables content creators to find their content alongside other content from other record labels, or more easily find content in large catalogs for large record labels, enabling easier discovery and licensing of content. Content creators may benefit from a faster way of identifying songs with desired characteristics and access to more songs to find more and different, and potentially better, matches than previously available.

Described herein are techniques that may mitigate or assist in addressing some of the above-described issues and improve content creators' access to music content and improve artists (e.g., writers of music content) access to content creators. A computer-implemented process may be provided in some embodiments that enables creators to discover the music content in a data set of music content, which in some examples described herein may be termed a media library or song library. Through some of the techniques described herein, independent artists may benefit from a streamlined import method for music content, automatic extraction of vibe attributes for music content, fast AI-powered search, iterative queries, a persistent workspace, and/or simplified licensing. For ease of description, in some examples below music content is described as songs, but it should be appreciated that embodiments are not limited to music content being a song or even an entire song, and that music content is not limited to include either or both of instrumental content and vocal content. For example, input media may include non-instrumental, non-vocal media, such as recordings of natural environments.

Media content may include an entirety of a media item or a segment of a media item and may further include instrumental content and/or vocal content.

Some embodiments of the system described herein may characterize music content according to vibe, or a combination of acoustic and/or emotive content of an input media item. Some systems that evaluate vibe may determine whether music content (e.g., whole songs or segments) match one another when the music contents share a vibe, have a similar vibe, or have vibes that meet one or more criteria for being considered a match. Vibe may characterize the music of the content and/or emotions associated with the content and may be or include one or more music attributes of the content.

In some embodiments, vibe may characterize, using such music attributes or other information, acoustic and/or emotive characteristics of the music content. Acoustic characteristics of the music content may describe sound structure of the music content. Emotive characteristics of the music content may be indicative how a listener is likely to react to the music content, such as an emotion that a listener may experience or associate with the music content.

Acoustic content may include vocal and non-vocal content. Vocal acoustic content (when the input media item includes vocal content) may in some cases include lyrics of the music content, including the text/words of the lyrics and/or audio of one or more people speaking, singing, or otherwise vocalizing the lyrics. Vocal content may also include non-word vocal content, such as musical vocalizations (e.g., for a cappella singing), vocal percussion (e.g., beatboxing), or other audible content created by a person. Instrumental content may include content of one or more music instruments playing. Such instruments may be traditional instruments, electronic instruments, synthesizers, or other sources of sound. Instrumental content may thus include non-vocal acoustic content.

Emotive content may include musical structures and/or lyrical structures tailored to evoke a particular emotion or emotions in a listener. In some examples, the system may characterize emotive content of an input media item based on musical prosody, lyrical content (e.g., word choice), melodic key(s), and/or harmonic structure (e.g., chord progressions).

The inventors have recognized and appreciated that song attributes can be used to characterize the vibe of music content (e.g., a song or a segment of a song). In some embodiments, attributes used to characterize the vibe of a piece of media can include musical tempo, musical key, presence of vocals, musical complexity, positivity, genre, instruments used, place of composition, and/or stylistic era.

Tempo may refer to the speed or pacing of a piece of music. In some examples, tempo can refer to whether music content is slow (downtempo) or fast (up-tempo). A tempo attribute may indicate the number of beats per minute in the music content (e.g., a given segment of a song). For some music content, this may be a single value that applies to the music content as a whole, while in further examples different segments of a piece of media may have different tempo values associated with them. The system may, in some embodiments, create an attribute value pair for different time ranges within the music content, such as for each tempo change. In the case where the tempo is smoothly changing (e.g., a ritard), the system may sample the tempo changes at a frequency that indicates the tempo curve.

Musical key may refer to a group of pitches (e.g., a scale) that form the basis for a piece of music. Keys may also be associated with a mode, such as major or minor key. Musical keys may be associated with particular pitches, chord progressions, etc. For some music content, musical key may be a single value that applies to the content as a whole, while in further examples different segments of a particular piece of music may be associated with different musical keys. The system may, in some embodiments, create attribute and value pairs for various time ranges within the music content, such as for each key change.

Presence of vocals may refer to whether or not vocal content is present in a particular piece of music. As with other attributes, some segments of a particular piece of music may have vocals while other segments may not. The presence of vocals attribute may therefore be an attribute that applies to a piece of media as a whole or to specific segments of the piece. The system may, in some embodiments, create attribute and value pairs for various time ranges within the music content, such as for when vocals start or stop. This attribute may be represented as a Boolean value indicating whether musical content (e.g., a piece as a whole or a specific segment) has a vocalist vocalizing (e.g., singing) or not. In some embodiments, a media analysis system may determine the gender of one or more vocalists that vocalize during the song or song segment.

Musical complexity may refer to whether music content has a simple, sparse arrangement of accompanying instrumentation or a complex dense arrangement of accompanying instrumentation. This attribute may characterize a number of tracks included in music content (e.g., a song or a segment of a song). As a particular example, music content may have a certain number of “tracks,” where each track corresponds to an instrument, vocalist, sound effect, or other audio included within the music content. The track count may be an expression of the number of tracks for the music content. In some embodiments, this attribute may be expressed as a ratio determined from the track count of the music content and using a baseline number of tracks. In some embodiments, a system may be configured to determine a maximum complexity for a particular set, grouping, or catalog of music, such as by identifying the number of tracks used in the musical piece with the greatest number of tracks in the set. In some such embodiments, the maximum complexity value may be used in the system to determine the complexity of a piece of music and/or a particular segment of a specific piece of media by calculating a ratio of a number of tracks of the music content with respect to the upper limit, where for the ratio 0 is a silent music content (e.g., no tracks present) and 1 is a music content of high/maximum complexity (e.g., a number of tracks equal to the maximum number of tracks identified in the set of media items).

Positivity may refer to the emotional content of music content. This attribute may be derived from the melodic key, lyrical sentiment, harmonic structure, and prosody for music content (e.g., at a given segment of a song). In some embodiments, positivity may be represented as a continuum between happy and sad, such as a number between 0 and 1 with 0 representing sad and 1 representing happy. As one example, if the melodic key is minor, then the music content may be considered melodically sad, otherwise it may be melodically happy. As another example, the sentiment of the lyrics may be analyzed, and that sentiment indicates if a given music content is lyrically happy or sad. Harmonic structure is the combination of chord progression and its interaction with the melody. The harmonic structure of music content is compared with other music contents determined to be happy or sad, and that is used to determine harmonic sentiment for music content. Prosody may be the way the frequencies, amplitudes, and durations of notes are combined in a given music content to evoke emotion. The prosody of a given music content may be compared with other music contents determined to be happy or sad, and that is used to determine prosodic sentiment for a music content. The system may in some cases use a weighting between lyrical, harmonic, melodic, and prosodic sentiment to determine if a music content is happy or sad.

Genre may refer to a broad categorization that identifies the piece of music as belonging to a shared tradition or set of conventions. In some examples, a particular genre may be associated with specific sets of instruments, such as amplified electric guitars being associated with rock genres. The genre attribute may additionally include sub-genres. For example, rock genres may include punk rock, classic rock, hard rock, and others. The system may determine the genre of a piece of music based on the number and types of instruments present in a piece, harmonic progressions used, or other features common to particular groupings of music.

Instruments used may refer to instruments used in a piece of music. This attribute may be a listing of instruments or identifiers associated with particular instruments. Instruments may include traditional instruments (e.g., pianos, violins, drums, etc.), electronic instruments, synthesizers, or other sources of sound. The system may determine which instruments are used in a particular piece based on an analysis of the acoustic properties of the input media, by identifiers associated with the various tracks used to compose a piece, or by any other suitable method.

Place of composition may refer to a physical location associated with the piece of music. Music may be influenced by where it was composed, and sometimes serves as a modifier to genre (e.g., Finnish power metal).

Stylistic era may refer to a time period that features styles associated with the musical composition. The song era may be the approximate year that songs were released that sound like the song segment. For example, a music content that sounds like (e.g., has one or more acoustic characteristics that match) classic disco might be assigned a song era of “1975”. In some embodiments, the era attribute value can be represented as a decimal number, equal to 1 when the song era matches the current year, and where 0 means the song era matches the year of the oldest known recorded track. In other embodiments, the era attribute value can be represented as a year, range of dates, an era name (e.g., “Classical” or “Baroque”) or any other suitable value for representing a period of time.

As described above, music content attribute may be determined for particular times or time ranges within a piece of music content. For example, each music content attribute may be represented as a series of value pairs, where the first member of the pair is a time or time range within music content and the second member of the pair is the value of the attribute at that time within the music content. A music content segment may be comprised of an entire song or a segment of a song, or other portion or entirety of music content. For each attribute, the system may determine how many value pairs would be beneficial for the attribute to characterize for search purposes a given segment of the song, examples of techniques for which are described below. The vibe of an entire song can be determined by using a single song segment that is the length of the song itself, or by aggregating the vibes of all the song segments.

As mentioned above, for case of description, examples are provided below in which music content is songs or segments of songs and in which a set of music content is a media library. It should be appreciated that embodiments are not limited to working with any particular type of music content.

A media library may include a set of songs, where each song comprises audio and is associated with song attributes. Song attributes may comprise descriptive attributes (e.g., name), quantitative attributes (e.g. tempo), qualitative attributes (e.g. mood), spectrogram, chromogram, lyrics and licensing terms, among other information identifying a song or characterizing the song and its content. Songs can be added to the media library in any suitable manner, including by uploading a single song or by bulk import from an existing catalog. Adding a song to a library may include storing song attributes for the song and may, in some embodiments, include storing an audio file for the song. The song attributes may be obtained for storage through input from a user, retrieval from non-audio data associated with a song file (e.g., metadata), retrieval from a data set of song information, analyzing audio data for the song to extract attributes, or in other manners.

A user interface may be provided for refining the results of a search if a content creator cannot find a suitable song.

A user interface may be provided for saving a song from the search results and accessing the set of saved songs.

As a particular example implementation of search, a user interface may be provided for choosing one or more songs and then finding one or more songs that have the same or a matching (e.g., meet one or more condition for a match) aggregate vibe. For each song in the input song list a user interface may be provided to select one or more segments of the song, and any unselected segments may be disregarded when determining the aggregate vibe. A user interface may be provided for viewing the vibe attributes of each input song. A user interface may be provided for removing a song from the input set so the query can be run again without the removed song. A user interface may be provided for viewing the aggregate vibe attributes used by the query. A user interface may be provided for adjusting the aggregate vibe attributes in order to run a revised query.

A user interface may be provided to see past queries and their results; e.g., the search history. A user interface may be provided to add annotations to search history.

A user interface may be provided for uploading a segment of video and then finding one or more songs that have the same or a matching vibe as the video.

A user interface may be provided for choosing a set of vibe attributes and the acceptable value range for each attribute and then finding one or more songs that have the vibe attributes within the specified ranges.

In some embodiments, a user interface may be provided to create a workspace. A workspace may be dedicated to finding suitable songs for all scenes of a video. A user interface may be provided to upload a video to a workspace. A workspace may be or include video files, search history, and notes.

A user interface may be provided for licensing a song from the song results.

Examples of techniques that may be implemented in some embodiments are described below. It should be appreciated that embodiments are not limited to operating in accordance with these examples, as other embodiments are possible.

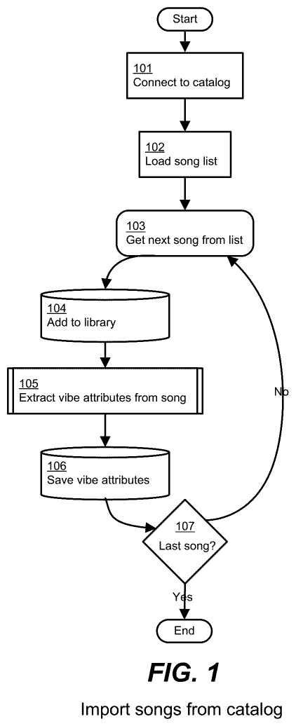

FIG. 1 is a flow diagram of an example method for adding media to a media library. At step 101, an automated media cataloging system connects to a catalog or database, either via a direct connection, an API, or a published feed. This catalog or database may be a music catalog provided by, for example, a record label or a batch of media provided by an independent artist.

At step 102, the media cataloging system may load a song list. In some examples, the media cataloging system may request a list of all songs in the catalog via the established catalog connection. The list of all songs may include audio files, metadata pertaining to the media files (such as artist name, album name, date of publication, etc.), and/or other information pertaining to each item of media.

At steps 103 and 104, the media cataloging system may select the next available song in the retrieved song list and add an entry for the corresponding audio file, name and any available descriptive data, such as song metadata, to the system's library.

At step 105, the media cataloging system may analyze the song for musical attributes and characterize the emotive and/or acoustic content of the song. This analysis process will be described in greater detail below.

At step 106, the media cataloging system may save the characterizations of the emotive and/or acoustic content to the system library along with the song data. In some embodiments, the song data may include an identifier of the song, such as an artist/title combination, a publication identifier, or other unique identifier of the song.

At step 107, the media cataloging system may check the song list to see if the processed song was the last song in the media list. If yes, the process ends. Otherwise, the media cataloging system may return to step 103, selecting the next song in the media list retrieved from the catalog or database.

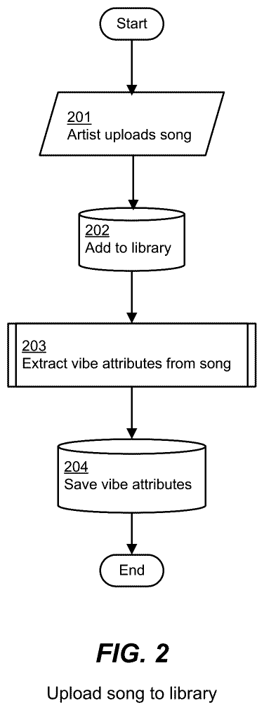

In some embodiments, a media cataloging system may include functionality allowing an artist to upload an individual song to the system library. FIG. 2 is a flow diagram of an illustrative method for uploading an individual song to a media library. In step 201, the artist may select a media file such as a song or video that includes audio to upload. In some examples, the artist may also add descriptive information; e.g., song name. In some embodiments, the media cataloging system may include a user interface to facilitate the upload process. The user interface may include a section to indicate a song or other media file for upload as well as fields for desired descriptive information such as song name, genre, date of composition, etc.

In step 202, the media cataloging system may add the song's audio file, name and other descriptive data to a media library. For example and as described above, the media cataloging system may assign a unique identifier to the media and associate the identifier with the descriptive information, then save the media identifier and associated descriptive information in a table or database. The system may store the media file itself in a media storage facility in association with the media identifier. The media file can later be retrieved via the identifier.

In step 203, the media cataloging system may extract musical attributes from the input media and characterize acoustic and/or emotive aspects of the song; this process will be described in greater detail below. In some embodiments, the media cataloging system may identify musical attributes of the song based on the descriptive information provided by the artist (e.g., genre, date of composition). Additionally or alternatively, the media cataloging system may perform acoustic, lyrical, or other analysis on the media file to determine the musical attributes of the song. The cataloging system may use these attributes to characterize the acoustic and/or emotive content of the media.

In step 204, the media cataloging system may save the characterizations of the acoustic and/or emotive content of the media in association with other elements of the song data. For example, in the above embodiment where the media cataloging system assigns a unique identifier to the media and stores the identifier in association with the artist-provided descriptive information, the media cataloging system may store the characterizations in association with the identifier and descriptive information.

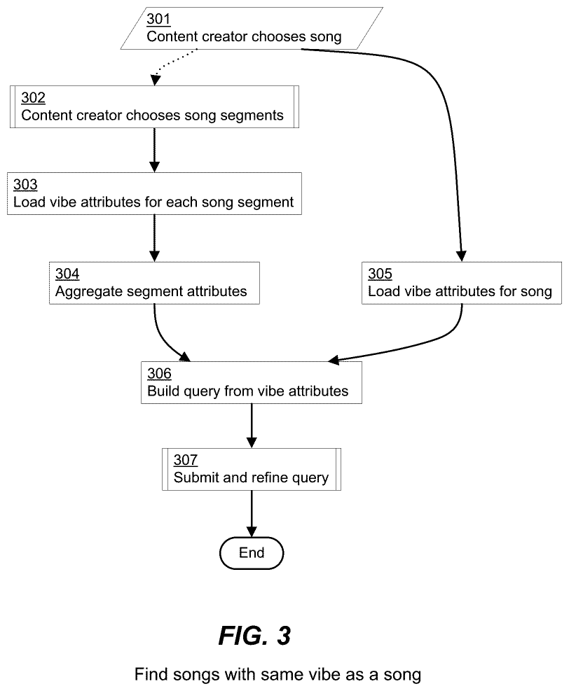

In some embodiments, a media search system may allow content creators to search a database or library of media, such as the media catalog described above, to identify matches to input media. FIG. 3 is a flow diagram of an illustrative method for searching a media library.

At step 301, a user such as a content creator can choose a song or other media item to provide as input to a media search system. For example, the user may upload a media file, provide a link such as a URL that indicates the media file, or select the media file via a streaming service such as Spotify.

At step 302, the user may optionally select song segments of the input media for analysis. For example, the user may specify particular time windows of the media for which to find matching media. In some embodiments, a user interface may allow the user to select segments via highlighting, sliders, or any other suitable way of indicating a desired song segment or segments. In some examples, the search system may search the media library based on the entire song, i.e., as a single segment. In further examples, the search system may allow users to indicate multiple segments of a single media item. When a user indicates specific song segments to use as part of a media search, the media search system may refrain from extracting attributes and/or determining characterizations of unselected segments of the input media.

At step 303, the media search system may load vibe attributes and/or characterizations for each segment indicated in step 302. If the song has been analyzed before (e.g., has a corresponding identifier stored in the media library), the media search system may retrieve the attributes from the media library. If the song is new to the system, the song may be added to the system media library per the process described above.

At step 304, the media search system may aggregate segment attributes and/or characterizations. In some examples, a media search system may aggregate attributes and/or characterizations of input segments in order to locate songs with a similar vibe to the indicated segments. In other words, the vibes of the songs from the input set can be aggregated into a single vibe. In some embodiments, the media search system may determine an aggregate value for each evaluated attribute. For example, the media search system may calculate an average of each numerical attribute across each piece of media in the input set. For non-numerical attributes, the media search system may use other types of aggregation. For example, the media search system may aggregate an attribute that has a binary value based on which value is more prevalent in the input set of media. For attribute types such as era, the media search system may generate a list of all musical eras represented in the input set of media or select a musical era that is represented more frequently than other musical eras represented in the media set. Other types of aggregation are possible, and a different aggregation method could be used for each vibe attribute.

In some examples, a user may select a song that is already indicated in the media library instead of uploading or otherwise indicating segments of a piece of media as described above. In these examples, instead of proceeding to step 302 from step 301, the method illustrated in FIG. 3 may instead progress from step 301 to step 305. In these embodiments, the media search system may retrieve the vibe attributes for the input media from the media library as opposed to calculating or extracting attributes from the input media.

Regardless of which branch of the method the media search system follows, at step 306 in FIG. 3, the media search system may construct a search query based on the vibe attributes of the indicated media and/or media segments. For example, the media search system may construct a vector that contains numerical representations of each attribute being used to search for matching media. In some embodiments, the query may include weighting values for each attribute. For example, some attributes may be preconfigured to be more important in identifying a matched item of media than others. In other examples, the media search system may include an interface to allow a user to indicate an importance of each or a subset of the musical attributes for finding a matched piece of media.

At step 307, the media search system may submit the query to the media library and output matched results. The media search system may determine that a piece of media in the media is a match in a variety of ways. In some examples, the media search system may identify a matching piece of media based on an identical vibe. In further examples, the media search system may identify a matching piece of media based on a non-identical match where one or more criteria for a match between parameters is determined.

The media search system may use different criteria for different attributes. In some embodiments, for example, one or more of the vibe attributes may be qualitative attributes that have non-numeric values, such as one of a set of values (e.g., true or false, or another set). Matching for such an attribute may include determining whether a song in a media library has the value or one of the values that was specified in the search for that attribute. Other attributes may have quantitative values, such as a numeric value, examples of which are described above. For such quantitative values, a match may be an identical match between a library song's attribute to an input value or a match to a range specified in the search and/or as a default parameter. Additionally or alternatively, the system may identify a piece of media as a match based on a non-identical match that indicates how closely (e.g., using a ratio) the value of the library song's attribute is to the value or range specified in the search. In some embodiments, the attributes may be equally weighted and the search system may identify a match based on whether a library song matches the value(s) specified for each indicated attribute for the search. In other embodiments, a user may be able to specify a weight associated with each attribute for the search, which may indicate a priority or importance to the user of each attribute in the search. The media search system may accordingly identify matching media based on how the attributes for media stored in the media library compare to the attribute specifications of the search; a song that does not match one attribute with a low weight but does match an attribute with a higher weight may be determined to be a match.

As a specific example of finding a match, the media search system may receive “The Main Theme to the Good, Bad, and Ugly” by Enrico Morricone as an input. After extracting musical attributes of the input and searching the media library for songs with similar characterizations of the musical and emotive content of the song, the system may determine that “Ghost Riders in the Sky” by Johnny Cash matches the vibe of “The Main Theme to The Good, Bad, and Ugly” on the basis of having a similar genre, tone, era, and involved instruments and therefore an overall similar acoustic characterization despite having a different tempo. The system may determine that “Bad Meets Evil” by Eminem is not a match to the input song because “Bad Meets Evil” has a different genre, tone, era, and involved instruments (and thus a different overall acoustic characterization) from the input song despite “Bad Meets Evil” sampling “The Main Theme to the Good, Bad, and Ugly.”

In some embodiments, the media search system may identify multiple matches. For example, the media search system may output a certain number (e.g., the top 10, top 20, or top 100) songs with vibes that are the most similar to the vibe specified in the search query. In some examples, the media search system may calculate a confidence level for each identified match. The confidence level may indicate a confidence that the matching media satisfies the input query. The confidence level may be a tiered qualifier (e.g., “high,” “medium,” or “low) or a percentage (e.g., 25% or 99%) that indicates a percentage confidence that the matched media item satisfies the input criteria. In these examples, the confidence level may be displayed in the user interface with each song. In some cases, the user interface may enable display of the list of matching songs ordered by confidence level, such as in decreasing order. The media search system may determine the confidence level based on a degree to which the attributes of the identified matched media differ from the attributes specified in the search query. Attributes may be assigned different weights in terms of their impact on the confidence level.

In some embodiments, the media search system may output one or more segments of the matched media item instead of the media item as a whole. For example, a particular song may have multiple sections, each with different vibes. The media search system may determine that one section of the song is a closer match to the input media item than another section of the song. The media search system may accordingly return the section of the song that is a closer match to the input media and refrain from returning the segments that are not as close of a match.

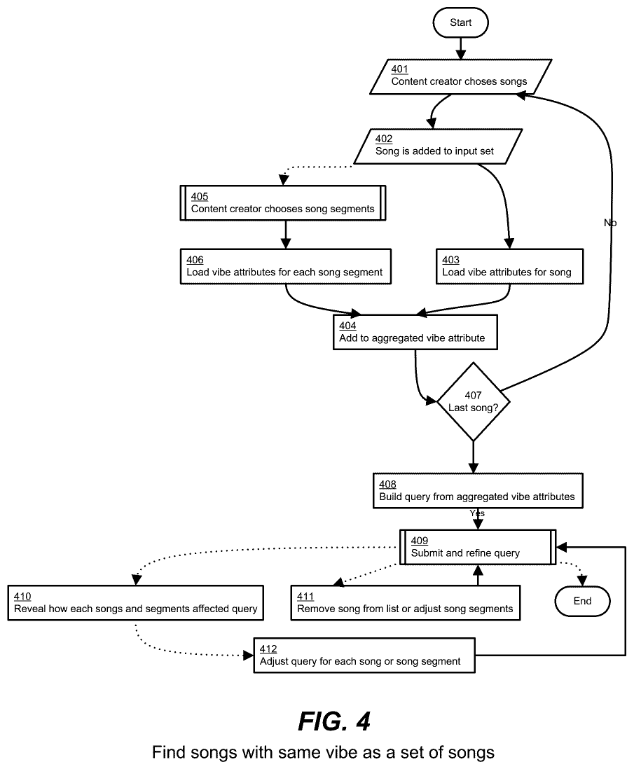

FIG. 4 is a flow diagram for an additional illustrative method for searching a media library. In step 401, a user such as a content creator can choose a song or other media item to provide as input. For example, the user may upload a media file, provide a link such as a URL that indicates the media file, or select the media file via a streaming service such as Spotify.

In step 402, the media search system adds the selected media to the input set. For example, the media search system may add the selected media and/or an indicator (e.g., an identifier, URL, etc.) that indicates the media to a list of media from which to build an aggregated query.

In step 403, the media search system may retrieve attributes for a song in the input set. If the song has been analyzed before, the attributes may be loaded from the system media library. If the song is new to the system, the song may be added to the system media library as described above.

In the event that the selected song of the input set is not represented in the system media library, the media search system may proceed to step 405 instead of step 403. In step 405, the media search system may receive an indicator of specific song segments to analyze. For example, a user may specify particular time windows of the media for which to find matching media. In some embodiments, a user interface may allow the user to select segments via highlighting, sliders, or any other suitable way of indicating a desired song segment or segments. In some examples, the search system may search the media library based on the entire song, i.e., as a single segment. In further examples, the search system may allow users to indicate multiple segments of a single media item.

In step 406, the media search system may analyze each selected segment (or the song as a whole) to determine media attributes and determine characterizations of the acoustic and/or emotive content of the selected segment or segments as described in greater detail above.

Regardless of which branch of the method the media search system follows, the media search system may aggregate attribute values. In step 404, the media search system may incorporate the attributes of the song into vibe aggregate values. In some embodiments, the media search system may update the aggregate values as each song in the input list is processed. In other embodiments, the media search system may determine media attributes for all songs in the list before calculating the aggregate values. These aggregate values may be determined in a variety of ways. In some embodiments, the media search system may determine an aggregate value for each evaluated attribute. For example, the media search system may calculate an average of each numerical attribute across each piece of media in the input set. For non-numerical attributes, the media search system may use other types of aggregation. For example, the media search system may aggregate an attribute that has a binary value based on which value is more prevalent in the input set of media. For attribute types such as era, the media search system may generate a list of all musical eras represented in the input set of media or select a musical era that is represented more frequently than other musical eras represented in the media set. Other types of aggregation are possible, and a different aggregation method could be used for each vibe attribute.

In step 407, the media search system may check to see if the processed media item was the last song or media item in the input set. If the processed media item was not the last song in the input set, the media search system may return to step 401, 402, 403, or 405 depending on the exact implementation of the above-described method. For example, in embodiments where a user provides a list of media items represented in the media library in steps 401 and 402, the media search system may return to step 403 to process the next media item in the list. In embodiments where the media search system is configured to receive media items one at a time, the media search system may return to step 401 and prompt the user to provide another media item. If the processed media item was the last song in the list (or the user indicates that they do not wish to add more songs to the input set), then the media search system may proceed to step 408 of the method.

Once the media search system has processed all the songs in the input set and calculated aggregated attributes and/or characterizations for the input set, in step 408, the media search system may build an aggregated query based on the aggregated vibe attributes. For example, the media search system may construct a vector that contains numerical representations of each aggregate attribute being used to search for matching media. In some embodiments, the query may include weighting values for each attribute. For example, some attributes may be preconfigured to be more important in identifying a matched item of media than others. In other examples, the media search system may include an interface to allow a user to indicate an importance of each or a subset of the musical attributes for finding a matched piece of media.

In step 409, the media search system queries the media library for media that matches the aggregate values of the input set and the results are shown to the user. At this step, the user may refine the query as will be described in greater detail below.

The method may include optional steps for adjusting the query and/or providing additional information to a user. In step 410, the media search system may provide visualizations for how a selected song or selected songs in the input set contributed to the aggregated vibe attributes. In one example, the media search system may display the vibe attributes for the selected song or songs. In another example, the media search system may display a pie chart for each vibe attribute, with a slice of each pie chart corresponding to a particular song in the input set. As a further example, the media search system may display a pie chart for each song, with a slice for each of the vibe attributes that the song contributed to.

The media search system may use the above-described visualizations to aid users in refining search queries. In step 412, the user can adjust how a selected song contributes to the aggregated vibe attributes. In some examples, the media search system may show the attributes used in the query and allow users to manually change the attribute values or value ranges that define a potential match. In some examples, the media search system may include a user interface that allows users to manipulate the pie charts described above, e.g., by changing slice sizes to change how the media search system considers the different attributes when constructing the aggregate vibe attributes and corresponding search query. In a further example, the media search system may allow users to adjust the weight of a song in the aggregated vibe, so the song has more or less impact on the results than other songs. Once the user has finished adjusting the parameters corresponding to the various input media items and/or attributes, the media search system may use the adjusted parameters to construct a new search query and return to step 409.

In embodiments where the input set includes indications of song segments, the media search system may use these segments instead the whole song to determine the aggregated vibe of the song input set. The media search system may aggregate the vibe attributes of each song segment when determining the overall aggregated attribute values for the input set. The media search system may use this set of aggregated song vibe attributes to calculate the aggregated song input set vibe attributes. The media search system can be configured such that longer song segments are weighted more heavily when calculating the aggregated song vibe attributes. The media search system may adjust other steps of the method to account for the use of song segments as opposed to whole songs. For example, in step 410, the media search system may display how each song segment affected the results in addition to displaying how the overall song affected the results. In step 411, the media search system can allow for adjustment of song segments instead of removing the song from the input set. In step 412, the media search system can adjust the effect of each song segment on the query in addition to the effect of the overall song.

In some embodiments, the media search system may enable searchers to remove songs from a query. In step 411, a user can remove a song from the input set. In these embodiments, the media search system may adjust the aggregated attributes to account for the removal of the song from the input set. The media search system may then generate a new query based on the adjusted aggregate attributes and return to step 409, using the new query to query the media library for matching media items.

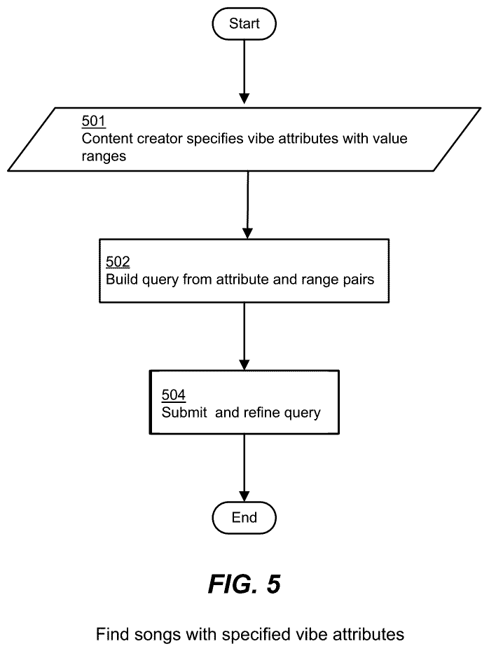

A user interface is provided to specify the vibe to search for by providing value ranges for each vibe attribute. FIG. 5 is a flow diagram of an illustrative method for conducting a media search using attribute ranges. In step 501, a media search system may receive vibe attributes with desired value ranges for each attribute from a content creator or other user. These inputs may be used to generate attribute-range pairs, i.e., an attribute with an associated desired range. The media search system may allow the user to select an exact value or a range of values to be used for each attribute. For example, the media search system may allow a user to select a range of tempos, such as “from 90 beats per minute to 150 beats per minute” versus a specific value, such as “exactly 120 beats per minute”.

In step 502, the media search system may construct a query using the attribute-range pairs specified in step 501. For example, the media search system may, for each song in the input set collate the attribute values into a corresponding vector that provides for numerical representations of the attribute values and/or value ranges.

In step 503, the media search system may query the media library and return results of the search. In some embodiments, the media search system may allow and/or prompt a user to refine the query, such as by the query refinement method(s) described above.

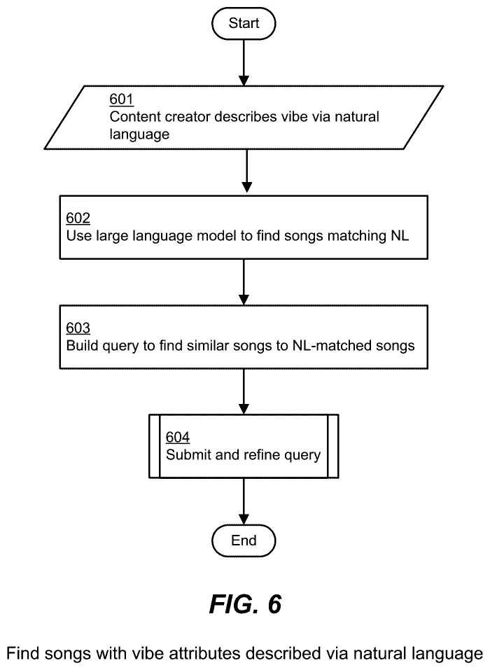

Some embodiments of the media search system described herein may enable users to search for songs using natural language (NL) queries. FIG. 6 is an illustrative method for using NL queries to search for songs that fit a particular vibe. In step 601, the user enters a NL description of the songs they want. Some examples of NL queries include “Slow, sad songs” or “Songs like Blue by the Jayhawks.”

At step 602, the media search system may process the natural language query using a machine learning model, such as a large language model (LLM), trained on a large song set. The model may respond with an indication of at least one song that matches the NL query. The media search system may thus be able to translate natural language inputs provided by users into indicators of media items that can then be used as inputs to the other systems and methods described herein.

In step 603 and 604, the media search system may query the media library and/or allow the user to refine the query according to the process described in FIG. 4 and detailed above.

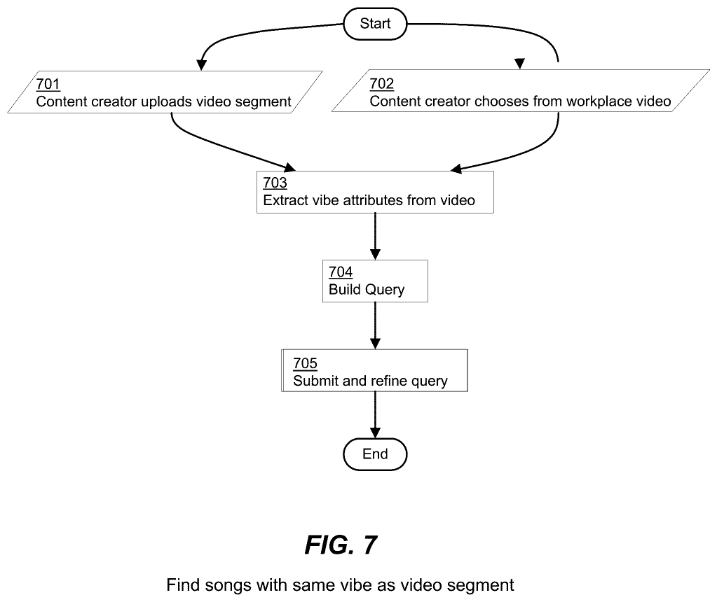

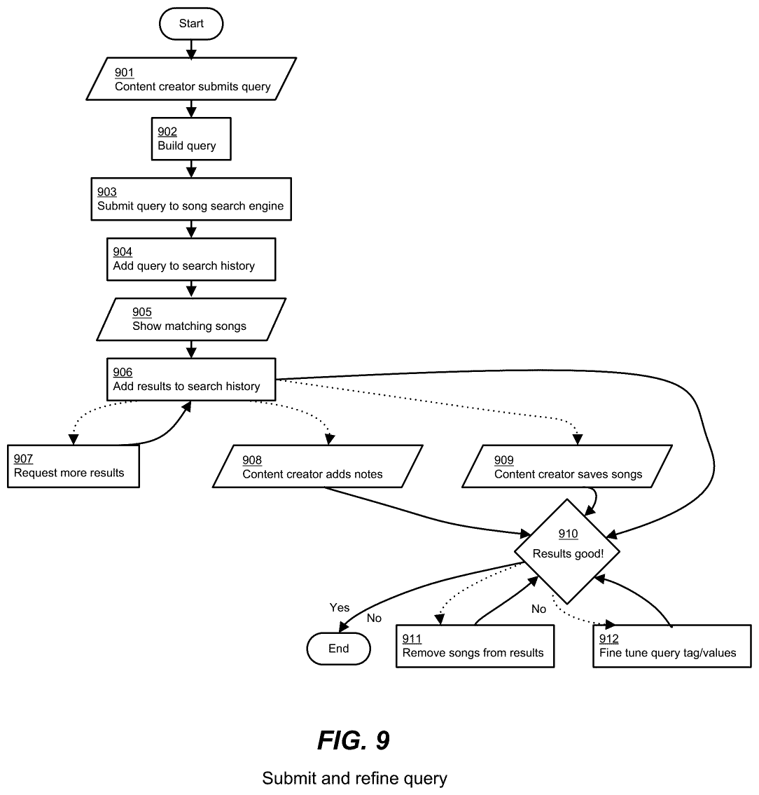

In some embodiments, the input media may include video. FIG. 7 is a flow diagram of an illustrative method for finding songs that have the same vibe as a video segment. In step 701 and 702, the media search system may obtain a video or chooses a previously uploaded video from the current workspace. Examples of workspaces will be provided in greater detail below. The media search system may then prompt a user to indicate scenes from the video to use for the search. In step 703, media search system may analyze the video scenes using a machine-learning model trained using supervised learning to associate characteristics of video segments with vibe attributes. If more than one video scene is selected, the media search system may aggregate the media attributes per the process described in greater detail above. In step 704 and 705, the media search system may construct a query based on the vibe attributes and query the media library using the constructed query. The media system may output the results of the search to the user, who can then refine the search; this process is described in FIG. 9 and detailed below.

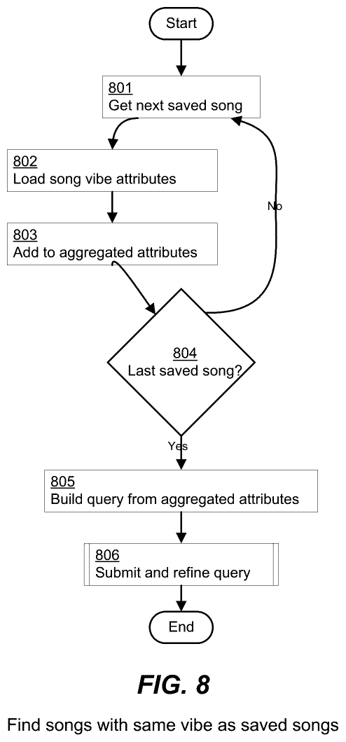

In some embodiments, a media search system may search for media that matches a saved song set (such as a playlist), thus finding new songs that match the aggregate vibe of the saved song set. FIG. 8 is a flow diagram of an illustrative method for finding song matches based on a saved song set. In step 801, the media search system may obtain indicators of the songs in the song set (e.g., title and artist, URL, or unique identifier) and retrieve or otherwise obtain a song from the saved set.

In step 802, the media search system may retrieve the vibe attributes for the saved song from the media library. As described in greater detail above, the media search system may store an entry for a media item along with its associated attributes, characterizations, and other information when the media item is submitted as a search query. Therefore, the media search system may have already determined characteristics and characterizations for songs that are saved as part of a song set.

At step 803, the media search system may add the attributes for the song to running aggregates for the attributes of the song set as described in greater detail above. In step 805 and 806, the media search system may construct a query based on the aggregate attributes and characterizations. The media search system may output the results of the search to, e.g., a user who can then refine the search; this process is described in FIG. 9 and detailed below.

In some examples, a content creator might not find the song they are looking for with their first search. The creator may thus wish to refine their search in order to find a song that matches a desired vibe. Finding a song can be an iterative process, and the media search system may store the history of the content creator's searches so that the content creator can referred back to and/or continue iterating on previous searches. Each item in the search history may include the query and the results. The media search system may allow users to refer back to items in the search history, refine the query for that item, and run a new query based on the refinements. This new query forms a new branch in the history, where the branch starts at the query item that was refined. A search history may thus be a tree that contains past query branches.

In some embodiments, a media search system may allow users to refine searches based on search results. FIG. 9 is a flow diagram of an illustrative method for performing and refining a search. In steps 901-903, a media search system may build a query based on a user input using one of the methods described above (e.g. similar songs).

In step 904 the media search system may save the query to the user's search history. For example, the media search system may save an indicator of the input song, aggregation weights for different attributes involved in the query, desired attribute ranges for different attributes involved in the query, and/or any other information relevant to the query such as a date and/or time at which the query was performed.

In step 905, the media search system may display results of the query to the user. In some examples, the media search system may assign a confidence value to each result returned by the query. As described above, a confidence value may be a value indicating a degree of closeness between the input media and the matched media. In some embodiments, the confidence value can be expressed as a percentage, 100% representing a perfect match (e.g., all evaluated attributes are identical) and 0% being the lowest possible confidence level. The media search system can display the confidence interval of each result with each song in the result set. The media search system can order display of the matched media items by confidence value in descending order.

In step 906, the media search system may add the matched media items to the search history in association with the query used to retrieve the matched media items.

The system will display a certain number of initial items in the result set, but in step 907 a user can request more results from the media search system. In some embodiments, the media search system may obtain these additional results by widening search criteria, such as desirable attribute ranges, in order to identify additional media that matches the input media. In other embodiments, the media search system may use the same search criteria and return matches that were not previously returned.

In step 908, the media search system may provide options for the user to add notes to the search. These notes may be saved to the search history in association with the associated query and results. In some embodiments, notes may include text strings submitted by the user to associate with the query. Additionally or alternatively, notes may indicate whether the user was satisfied with the search results or not, such as by a sentiment indicator. Such a sentiment indicator may be a thumbs up and/or thumbs down icon that the user can select to indicate a sentiment regarding the search. In some embodiments, the media search system may associate one or more of the notes with the search as a whole, i.e., a cohesive series of searches such as follow-up searches, adjusted searches, and/or other searches that derive from an original search. In other examples, the media search system may associate one or more of the notes with a specific search in a search series. In some embodiments, the media search system may provide an option to copy notes from one query or query series to another.

In some embodiments, a user may wish to save one or more songs returned by a search. In step 909, the media search system may prompt the user to indicate any songs from the active query that the user wishes to save. In some examples, the media search system may provide the prompt via the same user interface used to output the results of the search. Songs may be saved to a user's workspace, e.g., as indicators and/or links to the songs. In some examples, the media search system may maintain a list of songs saved by the user. In some embodiments, the media search system may export the list of saved songs in any of a variety of formats.

In step 910 the media search system may receive feedback indicating whether the user is satisfied with the results. If the user indicates that they are satisfied with the search results, the media search system may end the search.

If the media search system receives an indication that the user is not satisfied with the search results, in step 911 the media search system may prompt the user to remove one or more songs from the result set. The media search system may accordingly remove the song from the user's search history.

Additionally or alternatively, in step 912, the media search system may allow the user to revise or fine-tune the query such as by adding or removing songs from the input set, adjusting the importance of specific attributes, and/or by adjusting the importance of particular songs when determining the aggregate attributes with which to query the media library.

In some embodiments, the media search system may not create a new query when the user refines a query. In these embodiments, the media search may update the query instead. When the media search system updates a query, the notes from the original query may remain attached to the revised query. Additionally, the original query settings and/or results may not be reflected in a search history or search timeline. In some embodiments, the media search system may allow the user to view the iterations of a query. Updating queries in this way may allow users to make minor changes and/or refinements to search queries without unnecessarily cluttering their search history.

In some embodiments, a media search system may provide users with a “workspace.” A workspace may include video files, search history, saved media, notes, and/or other information that the user saves to the workspace. A workspace can be used to facilitate the process of finding songs for all needed scenes or segments of a video. In some examples, the media search system may allow users to save notes to the workspace and/or to a video or segments of video rather than to search queries or results. In some embodiments, workspaces may maintain workspace-specific search histories that record any queries submitted to the media search system while the workspace is an active workspace.

Although the examples described below discuss searching with a workspace, the media search system may not require users to have an active workspace in order to conduct media searches. In these examples, the media search system may provide an option for users to exit a workspace such that no workspace is marked as an active workspace. Search queries and/or results may be saved to a general user search history, allowing users to review past searches even when no workspace is active. In some embodiments, the media search system may include options to allow users to associate all or a portion of the general search history with a particular workspace. Similarly, the media search system may allow users to move all or a portion of a search history, notes, videos, and/or saved media from one workspace to another.

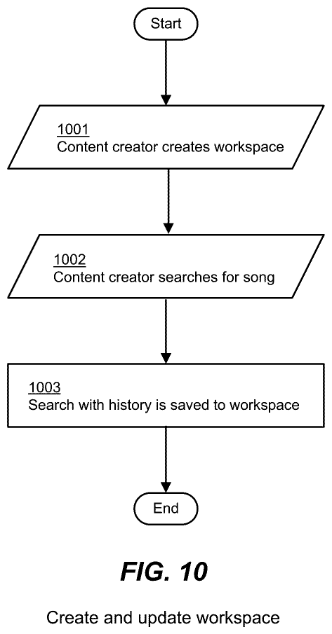

The media search system may update the workspace as a user performs searches. FIG. 10 is a flow diagram of an illustrative method for creating and updating a workspace. In step 1001, the media search system may receive a request from a content creator to create a new workspace. The media search system may set this newly created workspace the current or active workspace. In step 1002, the media search system may receive a query from the user. In step 1003, the media search system may add the query and/or search results to the search history of the active workspace. The media search system may likewise add any subsequent queries to the search history as well. If the user refines and/or updates a search query, the media search system may update the search query and/or results in the workspace search history.

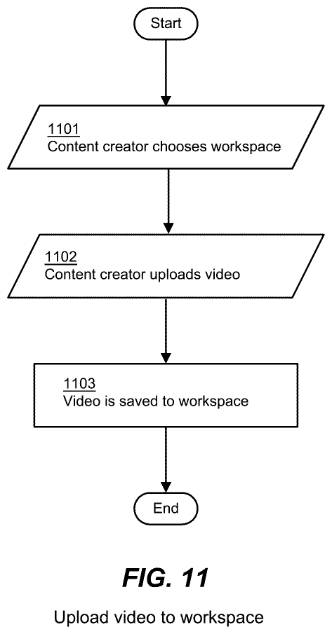

In some examples, users may upload video to a workspace. FIG. 11 is a flow diagram of an example method for uploading a video to a workspace. In step 1101, the media search system receives an indication of an active workspace and sets that workspace as the active workspace. In step 1102, the media search system may receive a video file from the content creator. In step 1103, the media search system may save the video to the active workspace.

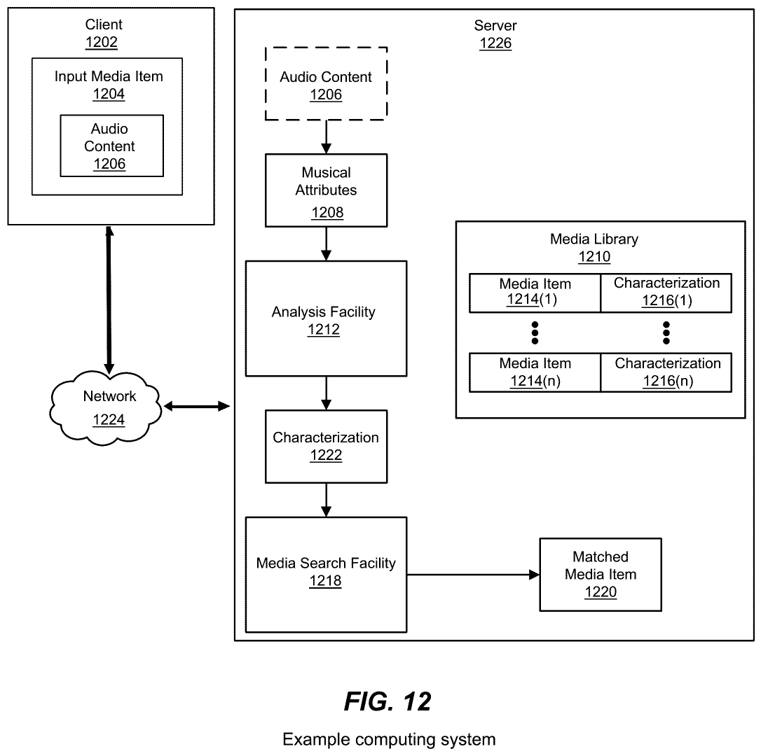

FIG. 12 is a block diagram of an illustrative system for performing media searches based on characterizations of acoustic and/or emotive content of input media. As illustrated in FIG. 12, a client 1202 may transmit an input media item 1204 that includes audio content 1206 to a server 1226 over a network 1224. Client 1202 and server 1226 may each be any suitable one or more computing devices, including personal computers, mobile devices, cloud computing systems, data centers, and the like. Network 1224 may be any suitable one or more wired and/or wireless, local- and/or wide-area computer communication networks operating according to one or more network protocols, including an enterprise network or the Internet. Embodiments are not limited to operating with any particular type of network. While an embodiment is illustrated in FIG. 12 that includes different functionality on a client 1202 and a server 1226, it should be appreciated that embodiments are not so limited. Any or all of the functionality of server 1226 may be integrated into one computing device with the functionality of client 1202 in other embodiments, including in a case that all functionality and data storage illustrated in FIG. 12 is performed on one device. In some other embodiments, media library 1210 may be hosted on one or more separate computing devices or computing systems and the remaining functionality of FIG. 12 may be performed on one or a combination of devices.

As described above, input media item 1204 can be a song, a segment of a song, video that includes audio, and/or any other suitable piece of input media. Server 1226 may extract musical attributes 1208 from audio content 1206 according to the methods described in greater detail above. Media analysis facility of server 1226 may determine a characterization 122 (sometimes referred to as a vibe) of audio content 1206. A media search facility 1218 of server 1226 may search media library 1210 for media items that match audio content 1206 based on characterization 1222. Media search facility 1218 may construct a query based on characterization 1222 to evaluate which of media items 1214(1)-(n) match input media item 1204. In some embodiments, media search facility 1218 may compare characterization 1222 to each of characterization 1216(1)-(n) to identify matching media. In this example, media search facility 1218 has identified a single matched media item 1120, though media search facility 1218 may identify any suitable number of matched media items. In some example, media search facility 1218 may return a preconfigured number of matched media items. In further examples, media search facility 1218 may retrieve additional matched media items in response to a user request for more matched media items. Once media search facility 1218 has identified matched media item 1220, server 1226 may output an indication such as a song title, URL, or publication number to client 1202 via network 1224.

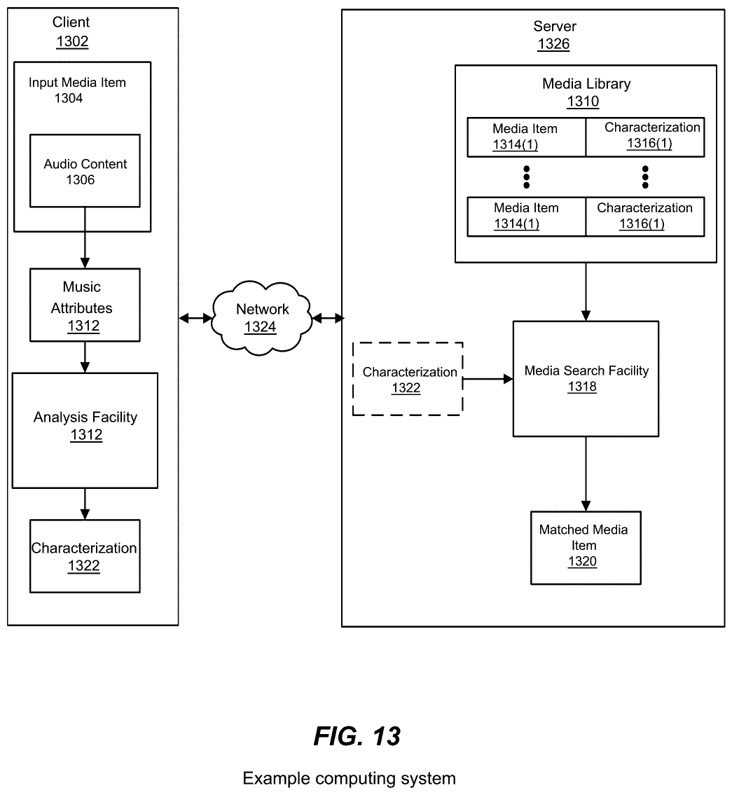

In some embodiments, a client device may characterize the media and submit the characterization as part of a query to a search service. FIG. 13 is a block diagram of an additional illustrative system for performing media searches based on characterizations of acoustic and/or emotive content of an input piece of media. As shown in FIG. 13, a client 1302 may identify an input media item that includes audio content 1306 and extract musical attributes 1308 from audio content 1306 of input media item 1304. Client 1302 may execute an analysis facility 1312 to determine characterization 1322 of input media item 1304 and transmit characterization 1322 to server 1326 over network 1324. A media search facility 1318 of server 1326 may receive characterization 1322 as input and search media library 1310 for media that matches characterization 1322. Media library 1310 may include a set of media items 1314(1)-(n), each with corresponding characterizations which are illustrated as characterizations 1316(1)-(n). Media search facility 1318 may construct a query for media library 1310 based on characterization 1322 and use the query to identify matched media item 1320. Ince matched media item 1320 has been identified, server 1326 may output matched media item 1320 or an indication of matched media item (e.g., a song title and artist pair, an audio file, a URL, etc.) to client 1302.

Although the examples of FIGS. 12 and 13 illustrate a search process involving a single media item, media search facilities 1218 and 1318 may be capable of receiving input sets of media as described above and/or receiving updated or fine-tuned searches from client devices. Similarly, although these examples show the media search facilities identifying a single matched media item, media search facilities may return any suitable number of matched media items as described in greater detail above.

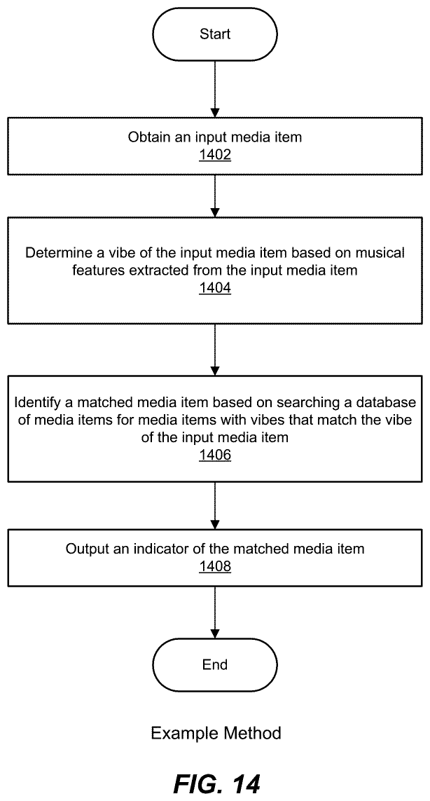

FIG. 14 is a flow diagram of an illustrative method for identifying media items that match the vibe of input media. At step 1402, the method may include obtaining an input media item. As described above, the media item may be an audio file, video that includes audio, an indication of a media item such as a link, an output of a natural language query, and/or any other suitable form of identifying a media item.

At step 1404, the method may include determining a vibe, or characterization of acoustic and/or emotive content, of the input media item based on musical features extracted from the input media item. This step may be performed by an analysis facility such as analysis facility 1212 and/or analysis facility 1312 as described above. An analysis facility may extract any suitable number and/or variety of features, including but not limited to musical tempo, musical key, presence of vocals, gender of a vocalist, musical complexity, positivity, genre, instruments, used, place of composition, and/or stylistic era.

At step 1406, the method may include identifying one or more matched media items based on searching a database of media items for media items with vibes that match the vibe of the input media item. As described in greater detail above, the overall vibe or feel of a song, audio track, or segment thereof may be characterized by the various musical attributes extracted from the input media. For example, a song may be characterized in natural language as “upbeat,” “heroic,” “thoughtful,” or other characterizations. While natural language characterizations are provided here by way of explanation, the systems and methods described herein may use any suitable characterization of the vibe of a media item, including numeric representations. This step may be performed by media search facilities, such as media search facility 1218 and/or media search facility 1318 as described above. Media search facilities may search a media library using any suitable method and/or technique to compare the characterization of the input media to the characterizations of media represented in the media library and identify one or more suitable matches.

At step 1408, the method may include outputting an indicator of the matched media item. In some examples, a media search system may maintain a library of audio files. A media search system may use an identifier retrieved by a media search facility to identify the appropriate audio file or segment of the audio file and return the file to the user or system that provided the input. In other examples, the media search system may output a URL that indicates the media, such as a URL for a landing page that provides download instructions for the media item. In further examples, the media search system may output a publication number or other unique identifier for the media, if available, that can be used to search for and retrieve the corresponding media files from a third party source such as a record label or other large music publisher.

As described in greater detail above, a media search system may search a media library based on a calculated vibe or characterization of acoustic and/or emotive content of an input media. The search system may perform a vibe-based search of a library of songs (and/or, in some cases, song segments or other content) to identify the song(s) from the library that have the matching vibe, in accordance with vibe match techniques described herein. It should be appreciated that embodiments are not limited to searching any particular library of songs. In some embodiments, the search system may perform a vibe-based search of a filtered library of songs (and/or, in some cases, song segments or other content). In some such embodiments, a filtering of the library may be performed to limit the songs that may be matched based on vibe. Prior to filtering, a library may be any suitable collection. The filtering may be done based on any suitable attribute, as embodiments are not limited in this respect. For example, filtering may be done based on attributes of songs, which may include information about the song itself, about an album of the song, about a publisher of the song, and/or about an artist of the song. A media library may store metadata associated with songs that indicates, for a song, one or more attributes identifying or characterizing the song, the album, the publisher, the artist, or other information. For example, artist information may include a name of the artist (or, in the case of a musical group, each artist), a geographic area associated with the artist (e.g., a city or geographic region they started in, currently live in, or publicly align themselves with), an age of the artist, or other information identifying or characterizing the artist. In some such embodiments, a user may input filter information as part of a search, such as by identifying a geographic area (e.g., city or region) of artists for whom songs should be included in search results. The filtering may in some cases be combined with vibe-based searching, so as to yield a list of songs that match a desired vibe and are associated with (e.g., written by, performed/recorded by, etc.) artists matching the identified geographic area.

### EXAMPLE IMPLEMENTATIONS

Techniques operating according to the principles described herein may be implemented in any suitable manner. Included in the discussion above are a series of flow charts showing the steps and acts of various processes that analyze vibe attributes of music content and search data sets of music content based on vibe attributes. The processing and decision blocks of the flow charts above represent steps and acts that may be included in algorithms that perform various processes. Algorithms derived from these processes may be implemented as software integrated with and directing the operation of one or more single- or multi-purpose processors, may be implemented as functionally-equivalent circuits such as a Digital Signal Processing (DSP) circuit or an Application-Specific Integrated Circuit (ASIC), or may be implemented in any other suitable manner. It should be appreciated that the flow charts included herein do not depict the syntax or operation of any particular circuit or of any particular programming language or type of programming language. Rather, the flow charts illustrate the functional information one skilled in the art may use to fabricate circuits or to implement computer software algorithms to perform the processing of a particular apparatus performing the types of techniques described herein. It should also be appreciated that, unless otherwise indicated herein, the particular sequence of steps and/or acts described in each flow chart is merely illustrative of the algorithms that may be implemented and can be varied in implementations and embodiments of the principles described herein.

Accordingly, in some embodiments, the techniques described herein may be embodied in computer-executable instructions implemented as software, including as application software, system software, firmware, middleware, embedded code, or any other suitable type of computer code. Such computer-executable instructions may be written using any of a number of suitable programming languages and/or programming or scripting tools, and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities performing techniques herein may together form a complete software package. These functional facilities may, in alternative embodiments, be adapted to interact with other, unrelated functional facilities and/or processes, to implement a software program application, for example as a software program application such as a signal analysis facility.

Some exemplary functional facilities have been described herein for carrying out one or more tasks. It should be appreciated, though, that the functional facilities and division of tasks described is merely illustrative of the type of functional facilities that may implement the exemplary techniques described herein, and that embodiments are not limited to being implemented in any specific number, division, or type of functional facilities. In some implementations, all functionalities may be implemented in a single functional facility. It should also be appreciated that, in some implementations, some of the functional facilities described herein may be implemented together with or separately from others (i.e., as a single unit or separate units), or some of these functional facilities may not be implemented.

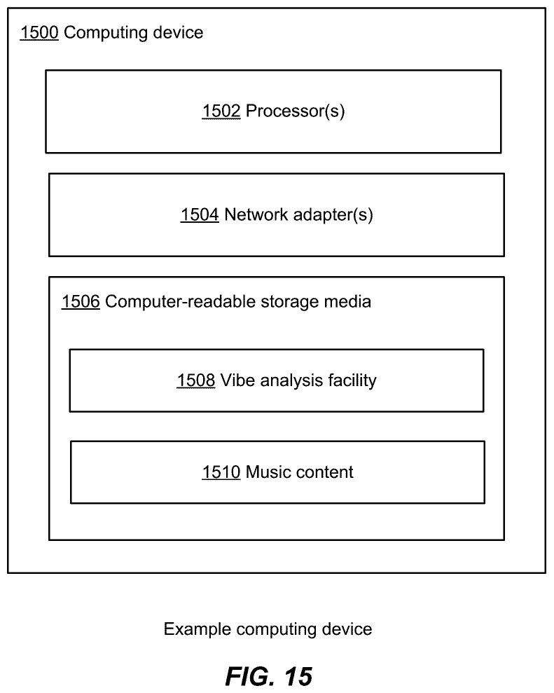

Computer-executable instructions implementing the techniques described herein (when implemented as one or more functional facilities or in any other manner) may, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium may be implemented in any suitable manner, including as computer-readable storage media 1506 of FIG. 15 described below (i.e., as a portion of a computing device 1500) or as a stand-alone, separate storage medium. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

In some, but not all, implementations in which the techniques may be embodied as computer-executable instructions, these instructions may be executed on one or more suitable computing device(s) operating in any suitable computer system, including the exemplary computer system of FIG. 15, or one or more computing devices (or one or more processors of one or more computing devices) may be programmed to execute the computer-executable instructions. A computing device or processor may be programmed to execute instructions when the instructions are stored in a manner accessible to the computing device or processor, such as in a data store (e.g., an on-chip cache or instruction register, a computer-readable storage medium accessible via a bus, a computer-readable storage medium accessible via one or more networks and accessible by the device/processor, etc.). Functional facilities comprising these computer-executable instructions may be integrated with and direct the operation of a single multi-purpose programmable digital computing device, a coordinated system of two or more multi-purpose computing device sharing processing power and jointly carrying out the techniques described herein, a single computing device or coordinated system of computing devices (co-located or geographically distributed) dedicated to executing the techniques described herein, one or more Field-Programmable Gate Arrays (FPGAs) for carrying out the techniques described herein, or any other suitable system.

FIG. 15 illustrates one exemplary implementation of a computing device in the form of a computing device 1500 that may be used in a system implementing techniques described herein, although others are possible. It should be appreciated that FIG. 15 is intended neither to be a depiction of necessary components for a computing device to operate as a device for controlling generation of an image that would result from an MRI scan in accordance with the principles described herein, nor a comprehensive depiction.

Computing device 1500 may comprise at least one processor 1502 (e.g., a computer hardware processor), a network adapter 3204, and computer-readable storage media 1506. Computing device 1500 may be, for example, a desktop or laptop personal computer, a personal digital assistant (PDA), a smart mobile phone, or any other suitable computing device. Network adapter 1504 may be any suitable hardware and/or software to enable the computing device 1500 to communicate wired and/or wirelessly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. Computer-readable media 1506 may be adapted to store data to be processed and/or instructions to be executed by processor 1502. Processor 1502 enables processing of data and execution of instructions. The data and instructions may be stored on the computer-readable storage media 1506.

The data and instructions stored on computer-readable storage media 1506 may comprise computer-executable instructions implementing techniques which operate according to the principles described herein. In the example of FIG. 15, computer-readable storage media 1506 stores computer-executable instructions implementing various facilities and storing various information as described above. Computer-readable storage media 1506 may store vibe analysis facility 1508 configured to perform techniques described herein. Computer-readable storage media 1506 may also store a data set of music content 1510, which may include attribute data for one or more items of music content.

While not illustrated in FIG. 15, a computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Embodiments have been described where the techniques are implemented in circuitry and/or computer-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

Having thus described several aspects of at least one embodiment, it is to be appreciated that various alterations, modifications, and improvements will readily occur to those skilled in the art. Such alterations, modifications, and improvements are intended to be part of this disclosure and are intended to be within the spirit and scope of the principles described herein. Accordingly, the foregoing description and drawings are by way of example only.

What is claimed is:

1. A method comprising:
determining a characterization of acoustic content and/or emotive content of audio of an input media based at least in part on a plurality of music attributes of the input media;
identifying one or more matched media that are a match to the input media, wherein identifying the one or more matched media comprises based on searching a set of media based on the characterization of acoustic content and/or emotive content of the input media to identify media having a matching acoustic content and/or a matching emotive content; and
outputting an identification of the one or more matched media as potential matches to the input media with respect to acoustic content and/or emotive content.

2. The method of claim 1, wherein the plurality of music attributes includes one or more of:
musical tempo;
musical key;
presence of vocals;
musical complexity;
positivity;
genre;
instruments used;
place of composition; or
stylistic era.

3. The method of claim 1, wherein the characterization of the emotive content of the audio is determined based on one or more of musical prosody, lyrical content, melodic key, or harmonic structure.

4. The method of claim 1, wherein the input media comprises video and the audio.

5. The method of claim 1, wherein:
obtaining the input media comprises obtaining a plurality of input media; and
determining the characterization of the input media comprises determining an aggregate characterization of the acoustic content and/or emotive content of the plurality of input media, wherein determining the aggregate characterization comprises evaluating at least some the plurality of music attributes for each media of the plurality of input media.

6. The method of claim 1, further comprising:
receiving an identification of the input media; and
obtaining the audio of the input media based on the identification of the input media.

7. The method of claim 6, wherein receiving the identification of the input media comprises:
receiving a natural language query for an item of media; and
translating, by a machine learning model, the natural language query into the identification of the input media.

8. The method of claim 1, wherein determining the characterization of the acoustic content and emotive content of audio of an input media comprises determining a characterization of a segment of the input media.

9. The method of claim 8, wherein determining the characterization of the segment further comprises refraining from determining characterizations of other segments of the input media.

10. The method of claim 1, wherein outputting the identification of the one or more matched media comprises returning one or segments of the one or more matched media.

11. The method of claim 1, wherein determining the characterization of acoustic content and emotive content of audio of the input media comprises determining the characterization of a plurality of segments of one or more input media.

12. At least one computer-readable storage medium having encoded thereon executable instructions that, when executed by at least one processor, cause the at least one processor to carry out a method, the method comprising:
obtaining an input media, the input media comprising audio;
determining a characterization of acoustic content and emotive content of audio of the input media based on a plurality of musical attributes extracted from the audio of the input media; and
storing an indicator of the input media in association with the characterization of acoustic content and emotive content of the audio.

13. The at least one computer-readable storage medium of claim 12, wherein storing the indicator of the input media further comprises storing the indicator of the input media storing in association with at least one of:
a spectrogram of the audio;
a chromogram of the audio;
lyrics of the input media; or
licensing terms of the input media.

14. The at least one computer-readable storage medium of claim 12, wherein storing the indicator of the input media further comprises storing attribute-time pairs in association with the characterization of acoustic content and emotive content of the audio, each attribute-time pair indicating a time in the input media at which a musical attribute in the plurality of musical attributes changes.

15. The at least one computer-readable storage medium of claim 12, wherein obtaining the input media comprises retrieving the input media from a published media data set.

16. The at least one computer-readable storage medium of claim 12, wherein the plurality of music attributes includes one or more of:
musical tempo;
musical key;
presence of vocals;
musical complexity;
positivity;
genre;
instruments used;
place of composition; or
stylistic era.

17. The at least one computer-readable storage medium of claim 12, wherein the characterization of the emotive content of the audio is determined based on one or more of musical prosody, lyrical content, melodic key, or harmonic structure.

18. The at least one computer-readable storage medium of claim 12, wherein the method further comprises:
receiving an identification of the input media; and
obtaining the audio of the input media based on the identification of the input media.

19. The at least one computer-readable storage medium of claim 12, wherein determining the characterization of the acoustic content and emotive content of audio of an input media comprises determining a characterization of a segment of the input media.

20. An apparatus comprising:
at least one processor; and
at least one storage medium having encoded thereon executable instructions that, when executed by the at least one processor, cause the at least one processor to carry out a method comprising:
determining a characterization of acoustic content and/or emotive content of audio of an input media based at least in part on a plurality of music attributes of the input media;
identifying one or more matched media that are a match to the input media, wherein identifying the one or more matched media comprises based on searching a set of media based on the characterization of acoustic content and/or emotive content of the input media to identify media having a matching acoustic content and/or a matching emotive content; and
outputting an identification of the one or more matched media as potential matches to the input media with respect to acoustic content and/or emotive content.
